(19) United States
(12) Patent Application Publication
(10) Pub. No.: US 2025/0199849 A1
(43) Pub. Date: Jun. 19, 2025

(54) METHODS AND SYSTEMS FOR PARALLEL PROCESSING OF BATCH REQUESTS USING A PLURALITY OF EVENT-SPECIFIC PROCESSING STREAMS

(71) Applicant: Capital One Services, LLC, McLean, VA (US)

(72) Inventors: Leandra IRVINE, San Jose, CA (US); Kevin M. MUDRICK, Oakland, CA (US); Leonhardt deWAAL, Orinda, CA (US); Xuan LI, Herndon, VA (US)

(73) Assignee: Capital One Services, LLC, McLean, VA (US)

(21) Appl. No.: 18/539,253

(22) Filed: Dec. 13, 2023

(51) Int. Cl. G06F 9/48

(52) U.S. Cl. CPC G06F 9/4881

(57) ABSTRACT

Methods and systems for parallel processing of batch requests using a plurality of event-specific processing streams. For example, the system may receive a plurality of requests for batch processing at a preset time. The system may process, with a scheduler service, a first event string of a first request of the plurality of requests. The system may direct the first request to a first processing service for processing within the preset time based on the first event identifier, wherein the first processing service processes the first request with a first processing service configuration file, wherein the first processing service configuration file is specific to the first processing service.

### BACKGROUND

Batch processing is a method used in computer systems for executing a series of tasks or jobs without user interaction. Batch processing typically involves collecting input data or programs into a group, known as a batch, and processing them together as a single unit. One example of batch processing is end of day processing. End of day processing refers to the tasks and procedures carried out by a computer system (e.g., corresponding to a business or organization) at the close of each business day. For example, end of day processing may involve a series of activities aimed at finalizing daily operations and preparing for the following day.

However, batch processing may strain computer resources in several ways. For example, batch processing often involves processing a large amount of data simultaneously. This can lead to increased memory usage as the computer needs to load and store all the data in memory. If the available memory is limited, it can cause the computer to slow down or even crash due to excessive memory usage. Batch processing also often involves processing a large amount of data simultaneously. This can lead to increased memory usage as the computer needs to load and store all the data in memory. If the available memory is limited, it can cause the computer to slow down or even crash due to excessive memory usage.

### SUMMARY

Accordingly, systems and methods are described for mitigating the memory and processing limitations imposed by batch processing. Moreover, the systems and methods provide improvements over conventional batch processing by implementing event-specific processing streams. To mitigate the aforementioned technical issues as well as to provide the event-specific processing streams, the systems and methods use a bifurcated processing service architecture that distributes load, allows for asynchronous processing, and avoids a shared database.

In particular, the bifurcated processing service architecture includes a first service layer (e.g., a scheduler service) that creates events and/or monitors for the events in incoming data streams. For example, as opposed to a conventional approach to batch processing, which involves applying a generated preexisting criterion across all received data, the scheduler service creates events that trigger additional logic and/or business rules defined by a configuration for a respective request. That is, as opposed to using a single event processing stream, a scheduler service directs individual requests to a specific service for processing that specific request based on event data in the request. Solving this technical problem provides the practical benefit of distributing load, allowing for asynchronous processing, and avoiding a shared database. Additionally, the bifurcated processing service architecture includes a second service layer (e.g., a library of event-specific processing services) that may perform different tasks and/or functions on a request based on the event.

For example, the scheduler service may process a first event string (e.g., text within the code of a request) of a first request of the plurality of requests in order to determine function to be performed on the request, determine a time stamp for the request that corresponds to the initial batch, and generate an event identifier for the request, wherein the event identifier indicates that the request corresponds to the function and the time stamp. Notably, the event identifier does not modify underlying data in the request and therefore does not risk further corruption of the data. The determination of the function allows for the system to direct the request to a processing service specific for the function. Furthermore, the determination of the time stamp allows the system to correlate the request (now processed in a processing service) to the original batch of requests and/or any time period or deadline for the batch processing related to that original batch. As such, the request (and all other requests in the batch) is able to be processed in parallel, avoiding the potential for bottlenecks.

In some aspects, systems and methods for parallel processing of batch requests using a plurality of event-specific processing streams are described. For example, the system may receive a plurality of requests for batch processing at a preset time. The system may process, with a scheduler service, a first event string of a first request of the plurality of requests, wherein the scheduler service: determines that the first request is for a first processing service; determines a first time stamp for the first request that corresponds to the preset time; and generates a first event identifier for the first request, wherein the first event identifier indicates that the first request corresponds to the first processing service and the first time stamp. The system may direct the first request to a first processing service for processing within the preset time based on the first event identifier, wherein the first processing service processes the first request with a first processing service configuration file, wherein the first processing service configuration file is specific to the first processing service.

Various other aspects, features, and advantages of the invention will be apparent through the detailed description of the invention and the drawings attached hereto. It is also to be understood that both the foregoing general description and the following detailed description are examples and not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion,” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative architecture for parallel processing of batch requests, in accordance with one or more embodiments.

FIG. 2 shows an illustrative diagram for processing requests using event-specific processing streams, in accordance with one or more embodiments.

FIG. 3 shows illustrative system components related to parallel processing of batch requests, in accordance with one or more embodiments.

FIG. 4 shows a flowchart of the steps involved in parallel processing of batch requests using a plurality of event-specific processing streams, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art, that the embodiments of the invention may be practiced without these specific details or with an equivalent arrangement. In other cases, well-known structures and devices are shown in block diagram form in order to avoid unnecessarily obscuring the embodiments of the invention. To do this, the system uses a configuration file to sort transactions that typically include event string encoded in proprietary formats without modifying the underlying data.

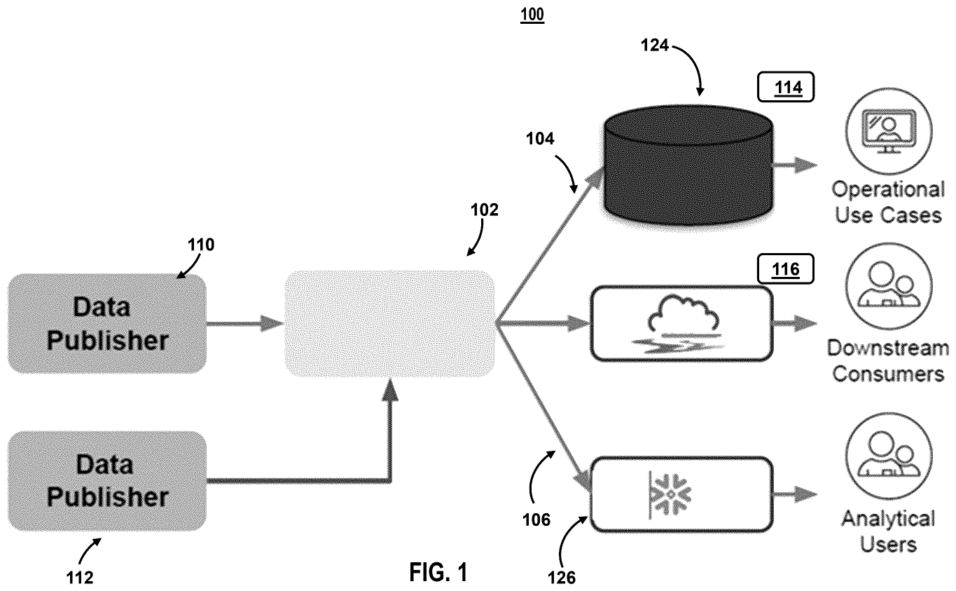

FIG. 1 shows an illustrative architecture for parallel processing of batch requests, in accordance with one or more embodiments. Batch processing is a method used in computer systems for executing a series of tasks or jobs without user interaction. Batch processing typically involves collecting input data or programs into a group, known as a batch, and processing them together as a single unit. For example, in a batch processing system, the requests may be submitted to a queue or a batch processing subsystem. The system may then process each request sequentially, one after the other, without requiring immediate user intervention.

As described herein, batch processing is commonly used in various scenarios, such as overnight data processing, report generation, large-scale data transformations, and/or system maintenance tasks. For example, the systems described herein may allow organizations to efficiently process large volumes of data or automate repetitive tasks, optimizing resource utilization and minimizing the need for continuous user interaction.

One example of batch processing is end of day processing. End of day processing refers to the tasks and procedures carried out by a computer system (e.g., corresponding to a business or organization) at the close of each business day. For example, end of day processing may involve a series of activities aimed at finalizing daily operations and preparing for the following day. End of day processing refers to the tasks and procedures carried out by businesses or organizations at the close of each business day. It involves a series of activities aimed at finalizing daily operations and preparing for the following day. In some embodiments, end of day processing may involve balancing and reconciling financial transactions, such as sales, purchases, and payments, to ensure accuracy and completeness. End of day processing may involve comparing cash register totals, verifying credit card transactions, and reconciling bank statements. End of day processing may also involve reporting and documentation. For example, businesses often generate various reports at the end of the day, such as sales reports, inventory reports, and employee productivity reports. These reports provide valuable insights into the day's activities and help in decision-making. Documentation may also include updating records, filing paperwork, and archiving relevant documents.

End of day processing may involve cash management. For example, for businesses that handle cash transactions, end of day processing typically involves counting cash, preparing bank deposits, and securing funds in a safe or cash register. Cashiers may also need to reconcile their cash drawer with the day's sales. End of day processing may also involve inventory management. For example, retailers and businesses with physical inventory often conduct end of day procedures to update inventory records. This may involve conducting stock counts, checking for discrepancies, and adjusting inventory levels based on sales or returns.

End of day processing may also involve system backups and maintenance. For example, many businesses perform system backups at the end of the day to ensure data integrity and protect against potential data loss. The system may also use this time to perform system maintenance tasks, such as software updates, database optimization, and network security checks. End of day processing may also involve preparation for the next day. For example, the system often includes preparing for the next business day. This can involve tasks such as restocking inventory, scheduling employee shifts, setting up displays or signage, and updating promotions or pricing information.

In some embodiments, an end of day processing (or a processing time for end of day processing) may correspond to preset time. For example, the system may determine a time stamp for a request corresponds to the preset time in order to trigger processing of the request. For example, a preset time may correspond to a predetermined or prearranged time that has been set in advance for a particular event or action to occur. It is a fixed time that is established beforehand, often programmed or preselected on a device or system.

For example, FIG. 1 shows system 100, which comprises a system for parallel processing of batch requests using a plurality of event-specific processing streams. For example, the system may use a bifurcated processing service architecture to separate different requests into different processing streams. By separating the transactions into separate processing streams, the system reduces bottlenecks, reduces required processing power, and/or performs event-specific processing.

For example, the system may receive a plurality of requests for batch processing at a preset time (e.g., a predetermined time). The system may then use a first portion (e.g., a scheduler service) of the bifurcated processing service architecture to process a first event string of a first request of the plurality of requests. The system may then use a second portion (e.g., one or more event-specific processing services from a plurality of processing services) to process a request.

As described herein, a request may comprise a user's or program's formal or informal demand for the system to perform a specific task or operation. It may involve various types of actions or commands that a user or program sends to a computer to initiate a particular operation. For example, a computer request can take different forms depending on the context and the interaction medium. For example, a request may comprise an action within a graphical user interface (GUI), such as opening a file or saving a document. A request may involve sending a command through a command-line interface (CLI), which may be a text-based interface for interacting with the computer system.

In some embodiments, a request may involve sending network requests over the Internet, such as requesting a web page from a server or submitting a form on a website. These requests typically use protocols like Hypertext Transfer Protocol (HTTP) to communicate between the client (user's computer or program) and the server (remote computer hosting the requested resources).

In some embodiments, a request may comprise a microservice request. For example, in a microservice architecture, a request may refer to a message or an action initiated by a client or another microservice to interact with a specific microservice. The request may represent a specific operation or task that needs to be performed by the receiving microservice. In some embodiments, the request may specify the target microservice or the specific operation to be executed within the microservice. The request may specify a type of operation to be performed, such as GET, POST, PUT, DELETE, etc. The request may specify additional metadata or information that provides details about the request, such as content type, authorization tokens, caching instructions, etc. The request may carry the data associated with the request, which can be in various formats like JSON, XML, or binary data. When the system receives a request, the system processes the request, performs the necessary actions or operations, and/or may generate a response back to the requester. The response may contain the result of the requested operation or any relevant information related to the request.

Each request may include an event. The event may comprise a message or notification that communicates a specific occurrence or state change within a microservice architecture, request, account, etc. It may represent a significant incident or data change that other microservices may be interested in or need to react to. For example, microservice events may follow a publish-subscribe pattern, where a microservice (publisher) generates an event and publishes it to an event bus or message broker. For example, as shown in system 100, events may be published to an event bus by scheduler service 102. Other microservices (subscribers) can subscribe to specific types of events and receive them for processing. The event bus acts as a mediator, distributing events to the interested subscribers. For example, generating an event identifier for a request may comprise the system determining an event in the request and select an event identifier from a plurality of event identifiers based on the event.

In some embodiments, the events may comprise event characteristics such as an event type, payload, and/or other metadata. As described herein, a “event characteristic” may comprise any characteristic of a request and/or event that distinguishes the request and/or event from another request and/or event. For example, an event characteristic may be compared against one or more criteria to determine a processing stream, function to be performed, and/or any other determinations related to the request. For example, an event type may categorize the event and helps subscribers filter and process the relevant events based on their interests. The payload may carry the data associated with the event. The payload may contain details about the occurrence or the state change that the event represents. Event characteristics may also include additional information about the event, such as a time stamp, event identifier, correlation identifier, or any other contextual data that can aid in event processing or tracing.

In some embodiments, the system may generate an event identifier. The event identifier may correspond to an event characteristic of an event. For example, generating an event identifier for a request may comprise the system determining an event in the request and select an event identifier from a plurality of event identifiers based on the event. The system may then determine whether a request corresponding to an event was completed. If not, the system may update the event identifier. For example, a request may comprise a marker command, which is streamed (or sent via HTTP) when a current time (wall time) exceeds an effective_time of an end of day process. If the command is not successful, then the retry_count field in the database is increased (e.g., a new identifier is generated) and the command will be retried at a later time. The system may then determine a new effective_time that is calculated by adding one day and the database row is updated. If a request is ever deleted, then the deleted field in the database is set to true.

Microservice events facilitate loose coupling between microservices and enable asynchronous communication. Rather than directly calling and coupling services together, microservices can publish events, allowing other services to react independently. This decoupling promotes scalability, resilience, and flexibility in the system, as microservices can independently react to events and adapt to changing requirements.

As shown in FIG. 1, system 100 includes a scheduler service 102. As shown in FIG. 1, scheduler service 102 may process requests (e.g., credit card transactions for processing on a given day) from one or more data sources (e.g., data source 110 and/or data source 112). Scheduler service 102 may process the plurality of requests to generate an event identifier that both indicates a source of the request and a time stamp (e.g., corresponding to the day or other time period during which the request was received).

Scheduler service 102 may generate a first processing service identifier and a second processing service identifier corresponding to a first request and second request, respectively. Based on the first processing service identifier, the first request is directed to the first processing stream or workflow (e.g., processing stream 104). Based on the second processing service identifier, the second request is directed to the second processing stream or workflow (e.g., processing stream 106). In some embodiments, the system may generate an embedded event into a request, which may comprise an embedding of an event identifier and/or event string into a request. For example, the system may generate an embedded event corresponding to the first request based on processing a first event string using a first embedding algorithm. For example, an event string, also known as a string or simply as text, is a group of characters that is used as data (e.g., for a data input). Text strings are most often comprised of words but may also include letters, numbers, special characters, symbols, and/or number signs.

In some embodiments, the event string may comprise content for which an operation may be performed. For example, the event string may indicate content (e.g., a word) and an operation (e.g., a search) to be performed using the content. For example, an operation may refer to any action or manipulation performed on data (or a database) to retrieve, modify, or manage data. For example, databases are structured collections of data that are organized and stored in a way that allows efficient processing of requests.

At processing stream 104, the first request is directed to a first processing service (e.g., processing service 124) where a first processing service processing unit is configured to process, with a first processing service configuration file (e.g., processing service configuration file 114), the first request, wherein the first processing service configuration file is specific to the first processing service. At processing stream 106, the second request is directed to a second processing service (e.g., processing service 126) where a second processing service processing unit is configured to process, with a second processing service configuration file (e.g., processing service configuration file 116), the second request, wherein the second processing service configuration file is specific to the second processing service.

For example, at the first processing service (e.g., processing service 124), the first processing service configuration file (e.g., processing service configuration file 114) may parse the first event string for data errors and generate an entity query based on the data errors. These data errors may be specific to the source and/or the presence of these data errors may be compliant with the source. In such cases, a generic configuration file (e.g., scheduler service 102) may have unnecessarily queried a source and/or other entity. While waiting for a response to this query, the system may have created an unnecessary bottleneck. For example, the system may parse the first event string identifier and generate an entity query based on the first event identifier.

In some embodiments, the processing service configuration file (e.g., processing service configuration file 114) may include parameters and/or protocols specific to a request, event (e.g., using an event-specific protocol), source, etc. For example, the first processing service configuration file (e.g., processing service configuration file 114) may retrieve data formatting parameters for the first processing service and may compare the first event string for the data formatting parameters. Additionally, or alternatively, the system may perform specific procedures that are customized to the source. For example, the processing service configuration file (e.g., processing service configuration file 114) may parse the first event string for data errors and process the first event string using an event-specific protocol.

In some embodiments, the first processing service configuration file (e.g., processing service configuration file 114) and/or the workflow (e.g., processing stream 104) corresponding to the first processing service (e.g., processing service 124) may have information available/accessible and/or the authorization to access/use information that is not available to a generic configuration file (e.g., scheduler service 102). For example, the system may determine a user profile for the first processing service corresponding to the first request (e.g., information that is only available to the first processing service). The system may then retrieve user account data for the user profile, and the system may determine adjustments to the user account data based on the first request. For example, processing stream 106 may perform one or more operations related to processing a request (e.g., a transaction file) such as determining eligibility of the request for one or more criteria, determining whether or not an event criterion (e.g., preset time) is met, and/or calculating modifications to user account data.

In some embodiments, the first processing service configuration file (e.g., processing service 124) and/or the workflow (e.g., processing stream 104) corresponding to the first processing service (e.g., processing service 124) may have rights to write information that is not available to a generic configuration file (e.g., scheduler service 102). For example, the system may write user account data (e.g., only available to the first processing service) to a staging database. The system may then aggregate the user account data to generate a status report, and the system may copy the status report to live databases for consumption by application programming interfaces.

As described herein, the processing stream (e.g., processing stream 104) may perform one or more operations involve in batch, partial batch, and/or individual processing of one or more requests. For example, the processing stream may receive a request submission. For example, the system may submit requests as a batch, partial batch, and/or individual requests. The submission may be based on an event and/or event characteristic and may include instructions or programs to be executed and the necessary input data.

The event, event identifier, and/or event string may include one or more event characteristics that specify a specialized scripting language called Job Control Language (JCL) to specify the request's requirements, such as resource allocation, dependencies, and execution parameters. The processing stream may then use a job scheduler to manage the execution of batch requests. The processing stream may receive requests, assign resources, and/or schedule the requests for processing based on priority, availability, and/or other criteria.

Requests waiting for execution may be placed in a request queue specific to the processing stream. The request scheduler for the processing stream may pull requests from the queue and allocates system resources to execute them. Once a job is selected from the queue, the processing stream may load a configuration file with the necessary programs, input data, and libraries required for execution. The request is then processed by the system without direct user interaction. The system may then generate output files or reports as specified by the request. These outputs may include processed data, error logs, status reports, and/or any other relevant information. If errors (or a lack of a response) occur during the request execution, the system may log the errors and may attempt to recover from them automatically or require manual intervention and/or resubmission. Error handling mechanisms ensure that the batch processing system can continue executing subsequent requests despite failures.

In some embodiments, system may receive requests from data source 110 and/or data source 112. Data sources may comprise a data stream. As referred to herein, “a data stream” may refer to data that is received from a data source that is indexed or archived by time. This may include streaming data (e.g., as found in streaming media files) or may refer to data that is received from one or more sources over time (e.g., either continuously or in a sporadic nature). A data stream segment may refer to a state or instance of the data stream. For example, a state or instance may refer to a current set of data corresponding to a given time increment or index value. For example, the system may receive time series data as a data stream. A given increment (or instance) of the time series data may correspond to a data stream segment.

A request may comprise any type of content. As referred to herein, “content” should be understood to mean an electronically consumable user asset, such as Internet content (e.g., streaming content, downloadable content, webcasts, etc.), video clips, audio, content information, pictures, rotating images, documents, playlists, websites, articles, books, electronic books, blogs, advertisements, chat sessions, social media content, applications, games, and/or any other media or multimedia and/or combination of the same. Content may be recorded, played, displayed, or accessed by user devices but can also be part of a live performance. Furthermore, user-generated content may include content created and/or consumed by a user. For example, user-generated content may include content created by another but consumed and/or published by the user.

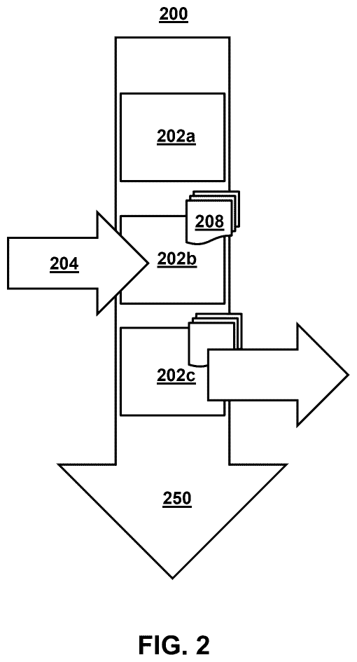

FIG. 2 shows an illustrative diagram for processing requests using event-specific processing streams, in accordance with one or more embodiments. For example, FIG. 2 shows diagram 200, which illustrates a request (e.g., request 202a-202c) being processed by a bifurcated processing service architecture (e.g., bifurcated processing service 250). In some embodiments, diagram 200 may represent an architecture for end of day processing in a way that supports a microservice architecture. The architecture may solve for separation of concerns of scheduling end of day processing in a financial system as well as distributing load, allowing asynchronous processing and avoiding a shared database. For example, end of day processing in a system may be triggered by marker events (e.g., referred to herein simply as events) sent by an end of day generator (e.g., a first service layer). The system may react to these events by triggering additional logic or business rules defined in the configuration for the respective financial contract (e.g., accrue interest, assess fees, activate account, etc.).

For example, diagram 200 may represent the life cycle of request 202 (e.g., represented by 202a-202c). For example, in a financial contract, a marker configuration is defined with a time and time zone, which indicates an end of day (EOD) time for that particular contract, which may correspond to request 202. The life cycle for these recurring tasks begins when the financial contract is provisioned in the system.

Bifurcated processing service 250 includes a first service layer (e.g., scheduler service 204) that creates events and/or monitors for the events in incoming data streams. For example, as shown in diagram 200, scheduler service 204 tags request 202a with an event (e.g., event 208) as reflected by request 202b. For example, upon account creation for a contract, an event is streamed out containing the full contract information to scheduler service 204. Event 208 may comprise a trigger for additional logic and/or business rules defined by a configuration for a respective request to be executed upon request 202b.

The system may add a time stamp to an event. A time stamp may be a record of the date and time when a particular event occurred or when a piece of data was created or modified. The time stamp may be represented in a specific format that includes the year, month, day, hour, minute, and second. The system may use time stamps to track the sequence and timing of events or to determine the age or freshness of data. The system may use time stamps for numerous purposes, including data synchronization, event logging, data versioning, auditing, and determining the order of operations or events. The system may use the time stamps to provide a standardized way to represent time and facilitate comparisons, sorting, and calculations involving time-based data.

A second service layer (e.g., a library of event-specific processing services 206) detects event 208 in request 202c and may perform different tasks and/or functions on request 202c based on event 208. For example, the second service layer may monitor the stream for new contracts to detect the new contract. The second service layer initializes an end-of-day task beginning on the provision date with the recurrence data and stores it to the database. A marker command may then be streamed (or sent via HTTP) when the current time (wall time) exceeds the effective_time (e.g., a preset time). If the command is not successful, then the retry_count field in the database is increased and the command will be retried at a later time. A new effective_time may be calculated by adding one day and the database row is updated. If a contract is ever deleted, then the deleted field in the database is set to true.

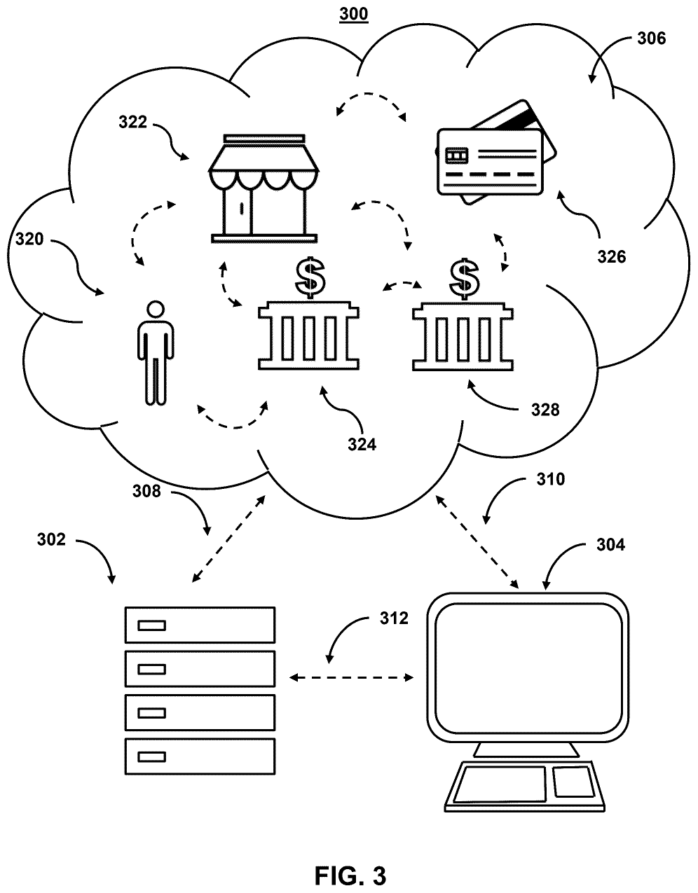

FIG. 3 shows illustrative system components related to parallel processing of batch requests, in accordance with one or more embodiments. As shown in FIG. 3, system 300 may include local server 302, user terminal 304, and cloud server 306. It should be noted that each component of system 300 may include additional subcomponents (e.g., additional servers and/or networks). System 300 may be used to process requests that may include user record data (e.g., data related to a transaction), resolve conflicts/corruptions, generate user queries, and/or compare source (e.g., merchant) data. It should be noted that server 302, user terminal 304, and server 306 may be any computing device, including, but not limited to, a laptop computer, a tablet computer, a hand-held computer, or other computer equipment (e.g., a server), including “smart,” wireless, wearable, and/or mobile devices. FIG. 3 also includes server 306. Server 306 may alternatively be any computing device as described above and may include any type of mobile terminal, fixed terminal, or other device. For example, server 306 may be implemented as a cloud computing system and may feature one or more component devices. It should also be noted that system 300 is not limited to three devices. Users may, for instance, utilize one or more other devices to interact with one another, one or more servers, or other components of system 300. It should be noted that, while one or more operations are described herein as being performed by particular components of system 300, those operations may, in some embodiments, be performed by other components of system 300. In some embodiments, the various computers and systems described herein may include one or more computing devices that are programmed to perform the described functions. Additionally, or alternatively, multiple users may interact with system 300 and/or one or more components of system 300. For example, in one embodiment, a first user (e.g., a credit card holder, an aggregation service, a credit provider, etc.) and a second user (e.g., a merchant/source, a credit card issuer, etc.) may interact with system 300 using two different components.

With respect to the components of server 302, user terminal 304, and server 306, each of these devices may receive content and data via input/output (I/O) paths. Each of these devices may also include processors and/or control circuitry to send and receive commands, requests, and other suitable data using the I/O paths and I/O circuitry. The control circuitry may comprise any suitable processing circuitry. Each of these devices may also include a user input interface and/or user output interface (e.g., a display) for use in receiving and displaying data. It should be noted that in some embodiments, the devices may have neither user input interface nor displays and may instead receive and display content using another device (e.g., a dedicated display device such as a computer screen and/or a dedicated input device such as a remote control, mouse, voice input, etc.). Additionally, the devices in system 300 may run an application (or another suitable program). The application may cause the processors and/or control circuitry to perform operations related to aggregating record data or resolving conflicts (e.g., either transmitting requests between components, receiving requests between components, and/or processing requests between components). For example, the processors may be programmed to provide information processing capabilities in the computing devices. As such, the processors may include one or more digital processors, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent processing functionality of a plurality of devices operating in coordination.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 308, 310, and 312. Communication paths 308, 310, and 312 may include the Internet, a mobile phone network, a mobile voice or data network (e.g., a 5G or LTE network), a cable network, a public switched telephone network, or other types of communications networks or combinations of communications networks. Communication paths 308, 310, and 312 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications paths or combination of such paths. The computing devices may include additional communication paths linking a plurality of hardware, software, and/or firmware components operating together. For example, the computing devices may be implemented by a cloud of computing platforms operating together as the computing devices.

Server 306 may be a database configured to store user data, process requests, record data, and/or process requests for aggregating user record data, resolving conflicts, generating user queries, and/or comparing source data. For example, the database may include user record data that the system has collected about the user through prior transactions. Alternatively, or additionally, the system may act as a clearing house for multiple sources of information about the user. Server 306 may also include control circuitry configured to perform the various operations needed to verify the identity of a user through contextual knowledge-based authentication.

In some embodiments, a request to process requests, authenticate transactions, aggregate user record data, resolve conflicts, generate user queries, compare source data, and/or generate similarity metrics may be structured as an application programming interfaces (APIs) request that includes a Uniform Resource Locator (URL), body, and method. The API request may correspond to one-half of the API request-response cycle between one or more devices and/or applications to complete the request. For example, the system may communicate in HTTP through a request-response cycle.

These requests may also direct a batch of request to a bifurcated processing service architecture. To make a valid request, the requester (e.g., server 302) may include a URL, method, list of headers, and/or body. The URL may indicate to server 306 (or other component) what resources to use. The body may contain headers and data. The headers may provide metadata about the request (e.g., the name of the requester, the user account for which access is needed, etc.) and the body may indicate the name of the user for which a request relates.

System 300 may be used for aggregating user record data, resolving conflicts, generating user queries, comparing source data, and/or generating similarity metrics. One component may be an application running on a mobile device of a user. As referred to herein, user record data and/or user account data may include any data related to a transaction. For example, the record data may include a paper or electronic record containing information about the transaction, such as transaction amount, transaction number, transaction date and time, transaction type (deposits, withdrawal, purchase, or refund), type of account being debited or credited, card number, and identity of the card accepter (e.g., merchant/source, including source address, identification or serial number, and/or terminal (e.g., name from which the terminal operates)). However, this information may be transmitted in a continuous text string. Continuous data may be data that can take any values.

Another component of the system shown in FIG. 3 is user terminal 304. User terminal 304 may allow a user to access and/or submit information for parallel processing of batch requests. User terminal 304 may also generate for display user queries. The various components of system 300 may work in conjunction to create a credit card transaction ecosystem.

For example, system 300 may involve multiple components and involve requests from one or more entities such as cardholder 320. A cardholder 320 may include a user that accesses an aggregation service in order to aggregate transactions of that user. For example, a given user may have multiple credit card accounts that correspond to a cardholder for multiple credit card networks. It should be noted that, as referred to herein, a credit card network may include debit cards, e-commerce accounts, source credit, and other electronic payment and/or monetary systems, such as online user currency accounts, cryptocurrencies, credit provider accounts, gift card accounts, etc.

System 300 may also include source 322, which may be associated with a store and/or vendor that sells goods and/or services to the cardholder. As referred to herein, a source may include a data source and/or correspond to a data source of one or more requests. Source 322, which may be a merchant, may accept credit card payments. Source 322 may also send card and/or user account information to, and request payment authorization from, an issuing bank of cardholder 320. Source 322 may be assigned information by a network upon registration. That information may include a merchant/source identifier (ID), a network name, and an address. The network may further generate a cleansed network name based on a native network name (e.g., a network name based on a proprietary and/or non-public algorithm for generating a network name based on available data of a merchant when the merchant registers with the network).

For example, as part of a request, a request from a source (or data source) may include various information about a request:
Merchant ID: 12345
Network Name: Josh's Board Game Store
Address: 1234 Main St., City, State 12346
   However, due to the conversion of the information in the request as it traverses the various components shown in FIG. 3, the information may be transmitted in a continuous data string that may or may not be human-readable. Source 322 may include an acquiring bank 324, which may also comprise an acquiring processor or service provider. For example, the acquiring bank may receive payment authorization requests from source 322 and send them to issuing bank 328 (which may include, or be a separate entity from, acquiring bank 324). The acquiring bank 324 may then relay a response from issuing bank 328 to source 322. In some embodiments, acquiring bank 324 may be a third-party entity. Acquiring bank 324 may provide a service or device that allows source 322 to accept credit cards as well as send credit card payment details to network 326. Upon receipt, network 326 may forward the payment authorization back to acquiring bank 324.

Network 326 may include entities that operate credit card networks that process credit card payments worldwide and govern interchange fees. In some embodiments, issuing bank 328 may form part of network 326. For example, issuing bank 328 may be a financial institution that issued the credit card involved in the transaction. Issuing bank 328 may receive the payment authorization request from the credit card network and either approve or decline the transaction.

During processing, the components of system 300 may use multiple naming conventions, formats, and value types of a category, value, etc., and these may differ from that of the user profile data (as stored on a user device or financial service provider). Server 306 (or other component of system 300) may use matching algorithms that may support exact match techniques and/or partial or “fuzzy” matching logic (e.g., searching for a closest or partial match) to locate alternate spellings, naming conventions, etc., for categories and/or value. For example, a column name associated with user data stored by an aggregation service may be compared to a category and/or value for the issuing bank 328. In another example, metadata associated with user data stored by a financial service provider (e.g., describing a transaction in the account of the user) may be compared to metadata of a corresponding record, entry, category, and/or value for the issuing bank 328.

In some embodiments, system 300 may compare data between system components at a transaction and/or request. For example, credit card transactions are processed through a variety of platforms, including brick-and-mortar stores, e-commerce stores, wireless terminals, and phone or mobile devices. The entire authorization cycle takes within two to three seconds, and the transaction process includes three stages of authorization, clearing, and settlement, in which clearing and settlement may take place simultaneously. In an authorization stage, source 322 must obtain approval for payment from issuing bank 328. Source 322 may transmit record data that may include: a credit card number, a card expiration date, a billing address (e.g., for address verification system (AVS)), a validation card security code (CVV), and/or a payment amount.

As the transaction moves through system 300, issuing bank 328 may receive the payment authorization request from network 326. Issuing bank 328 validates the credit card number, checks the amount of available funds, matches the billing address to the one on file, and validates the CVV number. Issuing bank 328 approves, or declines, the transaction and sends back an appropriate response to source 322 through system 300 (e.g., via network 326 and/or acquiring bank 324). Source 322 may receive the authorization, and issuing bank 328 may place a hold in the amount of the purchase on the account of cardholder 320. A point-of-sale terminal (e.g., user terminal 304) may send all approved authorizations to be processed in a “batch” (e.g., at the end of a day, accounting period, etc.). Notably, transmitting authorizations in batches increases the need for accurate and precise data and/or conflict resolutions at a high rate of speed.

During the clearing stage, the transaction is posted to both a credit card account of cardholder 320 and source 322. Source 322 then sends the approved authorizations in a batch to acquiring bank 324. Acquiring bank 324 then routes the batched information to network 326 for settlement. Network 326 forwards each approved transaction to an appropriate issuing bank 328. Issuing bank 328 will transfer the funds and may withhold exchange fees. Network 326 may also pay acquiring bank 324 a fee. Issuing bank 328 may then post the user record data to an account of cardholder 320.

Thus, a single transaction includes multiple systems each interacting with each other and handling user data that must be stored, transmitted, and verified in a precise manner. In order to ensure precision, each system and/or component of a system may use its own (and in many cases proprietary) encoding mechanisms. Additionally, or alternatively, source 322, acquiring bank 324, network 326, and/or issuing bank 328 each transmit a network name (e.g., an identification system used by an assigning party to indicate a source (e.g., source 322) corresponding to a transaction). However, as each system may use a private (and likely proprietary) algorithm for facilitating transactions, a network name generated and used by one component (e.g., network 326) may not be the same as the network name used by another network.

In some embodiments, other information may vary as well. For example, information about a source (e.g., address) may not be updated and/or correspond to a particular location, corporate headquarters, or other address for all transactions with the source. Likewise, time stamp information may be transmitted in different formats (or correspond to different time zones). Payment information may have slight variations due to fees charged by different system components. In such cases, the system may reconstitute the original charge made by the user (e.g., cardholder 320) based on exchange fee information.

Network name data is also not meant to be human-readable. That is, network name data is generated along with the proprietary security algorithms used by different system components, and this network name data may comprise a string of alphanumeric characters and/or other symbols that is used by each individual system component. The network name may be routinely encrypted, decrypted, and/or subjected to different proprietary algorithms for generating and translating data such that its original data value (e.g., a name of a source if the value was even originally based on the name of the source) may be irretrievable. As a benefit to human users, some credit card issuers and banks may cleanse this data in order to make it human-readable. That is, the credit card issuers and/or banks may apply a proprietary algorithm to make network name or other source data more human-readable.

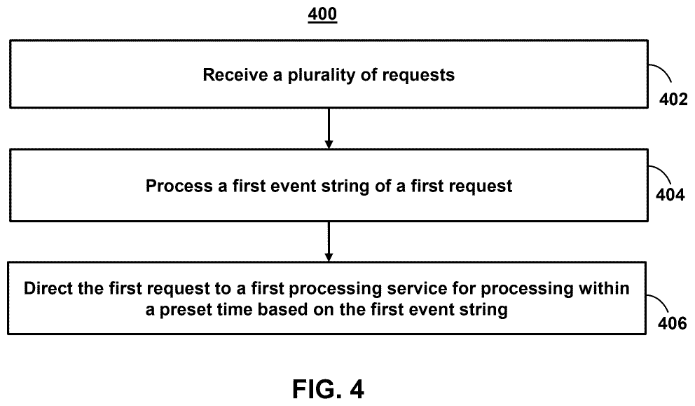

FIG. 4 shows a flowchart of the steps involved in parallel processing of batch requests, in accordance with one or more embodiments. For example, process 400 may be used to perform parallel processing of a batch of requests (e.g., credit card transactions) through the use of a plurality of processing services arranged in parallel, in which each processing service corresponds to a specific data source (e.g., a merchant).

At step 402, process 400 receives (e.g., by control circuitry of one or more of the components in FIG. 3) a plurality of requests. For example, the system may receive a plurality of requests for batch processing at a preset time. The plurality of requests may correspond to requests that need to be submitted to a third-party entity for batch processing at the preset time.

For example, the plurality of requests may include requests from numerous sources (e.g., numerous merchants and/or other entities as described in FIG. 3). These sources may include the first processing service and the second processing service, wherein each request of the plurality of requests comprises a respective event string, and wherein each request of the plurality of requests comprises a respective event string encoded in proprietary formats for the first processing service or the second processing service. For example, as the requests traverse a processing network (e.g., as described in FIG. 3), the request may be altered, converted, and/or modified.

At step 404, process 400 processes (e.g., by control circuitry of one or more of the components in FIG. 3) a first event string of a first request. For example, the system may process, with a scheduler service, a first event string of a first request of the plurality of requests. The scheduler service may determine that the first request is received from a first processing service, determine a first time stamp for the first request that corresponds to the preset time, and/or generate a first event identifier for the first request, wherein the first event identifier indicates that the first request corresponds to the first processing service and the first time stamp.

For example, the system may generate a first processing service identifier for the first request based on the scheduler service. The service identifier may comprise an event identifier that is based on a source of the request and a time (e.g., corresponding to the first time stamp) at which the request was received. However, in order to ensure the integrity of the request and in order to prevent corruption, the event identifier may not alter any information in the underlying request. Furthermore, as the event identifier is based on the time stamp, the event identifier may indicate a batch or a processing time required for the request. Accordingly, the system may direct the request away from an original batch and to another processing service without risking that the request will not be processed during the predetermined time (e.g., which may be set by a user, third-party entity, or system requirements).

For example, in some embodiments, the predetermined processing time may be variable. For example, to determine the predetermined time, the system may determine a number of the plurality of requests received. The system compares the number to a threshold number. In response to the number equaling or exceeding the threshold number, the system may determine a current date. The system may then determine the preset time based on the current date.

In some embodiments, the system may parse the first event string for a first event characteristic corresponding to a request source to determine that the first request is for the first processing service. The system may parse the first event string for a second event characteristic corresponding to a batch time stamp to determine the first time stamp for the second request that corresponds to the preset time. The system may then process the first event characteristic and the second event characteristic to generate the first event identifier for the first request.

In some embodiments, the system may process a second event string of a second request of the plurality of requests. For example, the system may process, with the scheduler service, a second event string of a second request of the plurality of requests. The scheduler service may determine that the second request is for a second processing service, determine a second time stamp for the second request that corresponds to the preset time, and/or generate a second event identifier for the second request, wherein the second event identifier indicates that the second request corresponds to the second processing service and the second time stamp.

Similarly, as stated above, the system may generate a second processing service identifier for the second request based on the scheduler service. The service identifier may comprise an event identifier that is based on a source of the request and a time (e.g., corresponding to the second time stamp) at which the request was received. However, in order to ensure the integrity of the request and in order to prevent corruption, the event identifier may not alter any information in the underlying request. Furthermore, as the event identifier is based on the time stamp, the event identifier may indicate a batch or a processing time required for the request. Accordingly, the system may direct the request away from an original batch and to another processing service without risking that the request will not be processed during the predetermined time (e.g., which may be set by a user, third-party entity, or system requirements).

Additionally, as the system uses the same configuration file for generating both the first and second event identifiers, any updates for the system may be made through modifying the same configuration file, increasing efficiency. In some embodiments, the configuration file may reference another configuration file (e.g., an update to the configuration file) as new sources are validated in the system. By doing so, the system may scale its processes without any downtime and/or affecting other processing workflows (e.g., corresponding to other processing services and/or sources).

At step 406, process 400 directs (e.g., by control circuitry of one or more of the components in FIG. 3) the first request to a first processing service for processing within a preset time based on the first event identifier. For example, the system may direct the first request to a first processing service for processing within the preset time based on the first event identifier, wherein the first processing service processes the first request with a first processing service configuration file, wherein the first processing service configuration file is specific to the first processing service. For example, the system may parse the first event identifier and generate a query based on the first event identifier.

For example, at the first processing service, the first processing service configuration file may parse the first event string for data errors and generate an entity query based on the data errors. These data errors may be specific to the source and/or the presence of these data errors may be compliant with the source. In such cases, a generic configuration file (e.g., a scheduler service that is not specific to a source) may have unnecessarily queried a source and/or other entity. While waiting for a response to this query, the system may have created an unnecessary bottleneck.

In some embodiments, the processing service configuration file may include parameters and/or protocols specific to the source. For example, the first processing service configuration file may retrieve data formatting parameters for the first processing service and may compare the first event string for the data formatting parameters. Additionally, or alternatively, the system may perform specific procedures that are customized to the source. For example, the processing service configuration file may parse the first event string for data errors and process the first event string using the first validation and enrichment protocol in response to detecting a data error.

In some embodiments, the first processing service configuration file and/or the workflow corresponding to the first processing service may have information available/accessible and/or the authorization to access/use information that is not available to a generic configuration file. For example, the system may determine a user profile for the first processing service corresponding to the first request (e.g., information that is only available to the first processing service). The system may then retrieve user account data for the user profile, and the system may determine adjustments to the user account data based on the first request.

In some embodiments, the first processing service configuration file and/or the workflow corresponding to the first processing service may have rights to write information that is not available to a generic configuration file. For example, the system may write user account data (e.g., only available to the first processing service) to a staging database (e.g., controlled by the first processing service). The system may then aggregate the user account data to generate a status report, and the system may copy the status report to live databases for consumption by application programming interfaces.

In some embodiments, the system may direct (e.g., by control circuitry of one or more of the components in FIG. 3) the second request to a second processing service for processing within the preset time based on the second event identifier. For example, the system may direct the second request to a second processing service for processing within the preset time based on the second event identifier, wherein the second processing service processes the second request with a second processing service configuration file, wherein the second processing service configuration file is specific to the second processing service.

For example, the system may perform one or more functions as described above but may use a different configuration file. For example, the configuration file and/or a validation and enrichment protocol may be specific to the second processing service and/or workflow.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, or in parallel, or substantially simultaneously to reduce lag or increase the speed of the system or method. Furthermore, it should be noted that any of the devices or equipment discussed in relation to FIG. 3 could be used to perform one or more of the steps in FIG. 4.

The above-described embodiments of the present disclosure are presented for purposes of illustration and not of limitation, and the present disclosure is limited only by the claims that follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method, the method comprising: receiving a plurality of requests for batch processing at a preset time; processing, with a scheduler service, a first event string of a first request of the plurality of requests, wherein the scheduler service: determines that the first request is for a first processing service; determines a first time stamp for the first request that corresponds to the preset time; and generates a first event identifier for the first request, wherein the first event identifier indicates that the first request corresponds to the first processing service and the first time stamp; and directing the first request to a first processing service for processing within the preset time based on the first event identifier, wherein the first processing service processes the first request with a first processing service configuration file, wherein the first processing service configuration file is specific to the first processing service.
2. The method of any one of the preceding embodiments, wherein the plurality of requests includes requests from the first processing service and the second processing service, wherein each request of the plurality of requests comprises a respective event string, and wherein each request of the plurality of requests comprises a respective event string encoded in proprietary formats for the first processing service or the second processing service.
3. The method of any one of the preceding embodiments, wherein the scheduler service: parses the first event string for a first event characteristic corresponding to a request source to determine that the first request is for the first processing service; and processes the first event characteristic to generate the first event identifier for the first request.
4. The method of any one of the preceding embodiments, further comprising: determining a number of the plurality of requests received; comparing the number to a threshold number; in response to the number equaling or exceeding the threshold number, determining a current date; and determining the preset time based on the current date.
5. The method of any one of the preceding embodiments, wherein the first processing service configuration file: parses the first event string for data errors; and generates an entity query based on the data errors.
6. The method of any one of the preceding embodiments, wherein the first processing service configuration file: parses the first event identifier; and generates a query based on the first event identifier.
7. The method of any one of the preceding embodiments, wherein the first processing service configuration file: retrieves data formatting parameters for the first processing service; and compares the first event string for the data formatting parameters.
8. The method of any one of the preceding embodiments, wherein the first processing service configuration file: parses the first event string for data errors; and processes the first event string using an event-specific protocol.
9. The method of any one of the preceding embodiments, wherein the first processing service is processed by: determining a user profile for the first processing service corresponding to the first request; retrieving user account data for the user profile; and determining adjustments to the user account data based on the first request.
10. The method of any one of the preceding embodiments, wherein the first processing service is processed by: writing user account data to a staging database; aggregating the user account data to generate a status report; and copying the status report to live databases for consumption by application programming interfaces.
11. The method of any one of the preceding embodiments, wherein generating the first event identifier for the first request further comprises: determining a first event in the first request; and selecting the first event identifier from a plurality of event identifiers based on the first event.
12. The method of any one of the preceding embodiments, further comprising: determining whether the first request is completed; and in response to determining that the first request is not completed, generating an additional identifier for the first request.
13. One or more non-transitory, computer-readable mediums storing instruction that, when executed by a data processing apparatus, causes the data processing apparatus to perform operations comprising those of any of embodiments 1-12.
14. A system comprising: one or more processors and memory storing instructions that, when executed by the processors, cause the processors to effectuate operations comprising those of any of embodiments 1-12.
15. A system comprising means for performing any of embodiments 1-12.

What is claimed is:

1. A system for parallel processing of batch requests using a plurality of event-specific processing streams comprising:
one or more processors; and
a non-transitory, computer-readable medium comprising instructions that when executed by the one or more processors cause operations comprising:
receiving a plurality of requests for batch processing at a preset time, wherein the plurality of requests includes requests from a first processing service and a second processing service, and wherein each request of the plurality of requests comprises a respective event string encoded in proprietary formats for the first processing service or the second processing service;
processing, with a scheduler service, a first event string of a first request of the plurality of requests, wherein the scheduler service:
determines that the first request is for the first processing service;
determines a first time stamp for the first request that corresponds to the preset time; and
generates a first processing service identifier for the first request, wherein the first processing service identifier indicates that the first request corresponds to the first processing service and the first time stamp; and
directing the first request to a first processing service for processing within the preset time based on the first processing service identifier.

2. A method for parallel processing of batch requests using a plurality of event-specific processing streams, the method comprising:
receiving a plurality of requests for batch processing at a preset time;
processing, with a scheduler service, a first event string of a first request of the plurality of requests, wherein the scheduler service:
determines that the first request is for a first processing service;
determines a first time stamp for the first request that corresponds to the preset time; and
generates a first event identifier for the first request, wherein the first event identifier indicates that the first request corresponds to the first processing service and the first time stamp; and
directing the first request to a first processing service for processing within the preset time based on the first event identifier, wherein the first processing service processes the first request with a first processing service configuration file, wherein the first processing service configuration file is specific to the first processing service.

3. The method of claim 2, wherein generating the first event identifier for the first request further comprises:
determining a first event in the first request; and
selecting the first event identifier from a plurality of event identifiers based on the first event.

4. The method of claim 2, further comprising:
determining whether the first request is completed; and
in response to determining that the first request is not completed, generating an additional identifier for the first request.

5. The method of claim 2, wherein the plurality of requests includes requests from the first processing service and a second processing service, wherein each request of the plurality of requests comprises a respective event string, and wherein each request of the plurality of requests comprises a respective event string encoded in proprietary formats for the first processing service or the second processing service.

6. The method of claim 2, wherein the scheduler service:
parses the first event string for a first event characteristic corresponding to a request source to determine that the first request is for the first processing service; and
processes the first event characteristic to generate the first event identifier for the first request.

7. The method of claim 2, further comprising:
determining a number of the plurality of requests received;
comparing the number to a threshold number;
in response to the number equaling or exceeding the threshold number, determining a current date; and
determining the preset time based on the current date.

8. The method of claim 2, wherein the first processing service configuration file:
parses the first event string for data errors; and
generates an entity query based on the data errors.

9. The method of claim 2, wherein the first processing service configuration file:
parses the first event identifier; and
generates a query based on the first event identifier.

10. The method of claim 2, wherein the first processing service configuration file:
retrieves data formatting parameters for the first processing service; and
compares the first event string for the data formatting parameters.

11. The method of claim 2, wherein the first processing service configuration file:
parses the first event string for data errors; and
processes the first event string using an event-specific protocol.

12. The method of claim 2, wherein the first processing service is processed by:
determining a user profile for the first processing service corresponding to the first request;
retrieving user account data for the user profile; and
determining adjustments to the user account data based on the first request.

13. The method of claim 2, wherein the first processing service is processed by:
writing user account data to a staging database;
aggregating the user account data to generate a status report; and
copying the status report to live databases for consumption by application programming interfaces.

14. One or more non-transitory, computer-readable mediums comprising instructions that when executed by one or more processors cause operations comprising:
receiving a plurality of requests for batch processing at a preset time;
processing, with a scheduler service, a first event string of a first request of the plurality of requests, wherein the scheduler service:
determines that the first request is for a first processing service;
determines a first time stamp for the first request that corresponds to the preset time; and
generates a first event identifier for the first request, wherein the first event identifier indicates that the first request corresponds to the first processing service and the first time stamp; and
directing the first request to a first processing service for processing within the preset time based on the first event identifier, wherein the first processing service processes the first request with a first processing service configuration file, wherein the first processing service configuration file is specific to the first processing service.

15. The one or more non-transitory, computer-readable mediums of claim 14, wherein the plurality of requests includes requests from the first processing service and a second processing service, wherein each request of the plurality of requests comprises a respective event string, and wherein each request of the plurality of requests comprises a respective event string encoded in proprietary formats for the first processing service or the second processing service.

16. The one or more non-transitory, computer-readable mediums of claim 14, wherein the scheduler service:
parses the first event string for a first event characteristic corresponding to a request source to determine that the first request is for the first processing service; and
processes the first event characteristic to generate the first event identifier for the first request.

17. The one or more non-transitory, computer-readable mediums of claim 14, wherein the instructions further cause operations comprising:
determining a number of the plurality of requests received;
comparing the number to a threshold number;
in response to the number equaling or exceeding the threshold number, determining a current date; and
determining the preset time based on the current date.

18. The one or more non-transitory, computer-readable mediums of claim 14, wherein the first processing service configuration file:
parses the first event string for data errors; and
generates an entity query based on the data errors.

19. The one or more non-transitory, computer-readable mediums of claim 14, wherein the first processing service configuration file:
parses the first event identifier; and
generates an entity query based on the first event identifier.

20. The one or more non-transitory, computer-readable mediums of claim 14, wherein the first processing service configuration file:
retrieves data formatting parameters for the first processing service; and
compares the first event string for the data formatting parameters.
